(19) United States
(12) Patent Application Publication
(10) Pub. No.: US 2016/0005136 A1
(43) Pub. Date: Jan. 7, 2016

(54) Method of, and a System for, Analysing Data Relating to an Individual

(71) Applicant: Warren John PARRY, Cremorne, New South Wales (AU)

(72) Inventor: Warren John Parry, Cremorne (AU)

(21) Appl. No.: 14/771,111

(22) PCT Filed: Mar. 11, 2014
(86) PCT No.: PCT/AU2014/000236

§ 371 Date: Aug. 27, 2015

(30) Foreign Application Priority Data
Mar. 13, 2013 (AU) 2013900860

(51) Int. Cl. G06Q 50/00; G06F 3/0484

(52) U.S. Cl. CPC G06Q 50/01; G06F 3/04842

(57) ABSTRACT

A data analysis system (10) for analysing data relating to an individual (12) includes a physical computer based data generator (16) for creating input data relating to an individual (12). A physical computer processor (18) is responsive to the data generator (16). The processor (18) is configured as a data analysis engine containing pattern recognition software and is configured to manipulate and transform the input data to generate output data. An output module (26), configured as a part of the processor, provides the output data to the individual (12) in the form of a personal map (28), the map (28) being the individual's personal map containing that individual's personal data relating to life experiences of the individual. A storage module (25) is associated with the processor (18) for storing the personal map (28). A tools module (30) is in communication with the processor (24) and is accessible by the individual (12) for enabling the individual (12) to personalise his or her personal map (28).

### CROSS-REFERENCE TO RELATED APPLICATIONS

The present application claims priority from Australian Provisional Patent Application No 2013900860 filed on 13 Mar. 2013, the contents of which are incorporated herein by reference.

### TECHNICAL FIELD

This disclosure relates, generally, to data analysis techniques and, more particularly, to a method of, and a system for, analysing data relating to an individual with a particular, but not necessarily exclusive, aim of assisting an individual to achieve his or her life goals.

### BACKGROUND

Life experiences have played out in numerous ways across populations, cultures, etc. People have tried, with varying rates of success, to resolve issues and challenges that they have faced or are facing in their lives. Choices are varied and the links to outcomes as a result of actions are extremely complex. To date, there have not been measurement and analytical tools available to enable people to share their experiences and to benefit from the experiences of others short of forums such as group therapy, etc. Many people are reluctant to participate in such forums for fear of being stigmatised. In addition, interpreting patterns of behaviour requires expertise, for example, that of a suitably qualified therapist and limited codified outcomes are available.

In addition, while there are increasing numbers of people using social media networks, such networks are used at a very superficial level. While the social media networks help people to connect and share, the social media networks do not provide tools that help people gain insight into, or a deeper understanding of, the nature of their relationships, both with family and friends and the communities in which they participate. Social media networks also do not assist people to identify critical issues in their lives or help/guide people into what they can do about those issues, i.e. what leads to success in the lives of others. In other words social media networks do not provide value added tools to enable an individual to analyse his or her life journey and life experiences. Existing social media networks do not provide measurement parameters which can be used by an individual to assess, improve and track progress in that individual's life journey.

### SUMMARY

In a first aspect, there is provided a method of analysing data relating to an individual, the method including

providing input data relating to an individual to a physical computer processor configured as a data analysis engine containing pattern recognition software;

using the processor to manipulate and transform the input data to provide output data;

using the processor to transform the output data into the form of a personal map and storing the map, the map being the individual's personal map containing that individual's personal data relating to life experiences of the individual; and

providing tools to enable each individual to personalise his or her personal map.

The method may include obtaining the input data from the individual by having the individual complete a questionnaire containing a suite of questions. Each question may have a graded series of answers.

The method may include periodically updating the map by plotting new responses on the map and using the processor to update the map. This enables the individual to see if he or she is on track to achieving targets and also shows what needs to be done to remain on track or to achieve the target. Further, the method may include, when updating the map, retaining personalisation of the map previously added by the individual.

The method may include, in addition to using the tools, personalising the map by tailoring questions to be answered by the individual. In addition, the method may include using a web-based selection of tools to personalise the map.

The map may be an individual map and, in another embodiment, the method may include combining the individual maps of a number of individuals to generate a group map. The method may include generating the group map by combining input data from members of the group who wish to combine their individual maps to form the group map, the processor linking and combining the input data to output the group map.

The method may include adding members to, or removing members from, the group as desired by combining or deleting the input data of the members as required.

In a further embodiment, the method may include generating a community map from the input data of a plurality of individuals, each of whom is a member of the community.

In a still further embodiment, the method may include generating a global map from the input data of many individuals. The method may include enabling the individual to access the global map to compare the situation of that individual with other individuals whose input data has contributed to the global map.

The method may include enabling an individual to plan a course of action, and monitor progress as the individual takes action, on the global map.

Further, the method may include using social media networks for accessing the global map.

The method may include, using web-enabled tools and analytics functionality of the processor, enabling individuals to share information and access other web amenities such as wikis, on-line resources, etc.

By customising the input data to the global map, the method may include generating a sub-population map containing special interest information. Hence, the method may include enabling the individual to access the sub-population map to assess and track progress in relation to the special interest to which the special interest information relates.

In a second aspect, there is provided a method of analysing data relating to an individual, the method including

providing input data relating to an individual to a physical computer processor configured as a data analysis engine containing pattern recognition software;

using processor to manipulate and transform the input data to provide output data;

using the processor to transform the output data into the form of a personal map and storing the map, the map being the individual's personal map containing that individual's personal data relating to life experiences of the individual; and

using the processor to monitor change arising from one point on the map to another point on the map by the individual inputting different input data into the processor.

Thus, by using the map, the individual is able to monitor changes from one life event to the next, go back in time to a past event, or the like.

In a third aspect, there is provided a data analysis system for analysing data relating to an individual, the system including

a physical computer based data generator for creating input data relating to an individual;

a physical computer processor responsive to the data generator, the processor being configured as a data analysis engine containing pattern recognition software and the processor being configured to manipulate and transform the input data to generate output data;

an output module configured as a part of the processor, the output module providing the output data to the individual in the form of a personal map, the map being the individual's personal map containing that individual's personal data relating to life experiences of the individual;

a storage module associated with the processor for storing the personal map; and

a tools module in communication with the processor and accessible by the individual for enabling the individual to personalise his or her personal map.

The input data, when received, may form part of source data for future use, the system including a database containing the source data.

The processor may be configured to perform cluster analysis at least on the input data to produce reference data. The form of cluster analysis performed may be non-linear, multivariate, dimension reduction. The non-linear, multivariate, dimension reduction may use a self-organising map algorithm (SOM) for organising the reference data into a matrix from which the map is generated.

The data generator may include a questionnaire, preferably an on-line questionnaire, to be completed by the individual. The questionnaire may contain a plurality of questions, each having a range of graded responses.

The data analysis engine functionality of the processor may be configured to transform the input data into an analysis file to be processed by the processor. The analysis file may include input variables which are processed by the processor to generate the output data.

The data analysis system may include presenting the map as a two dimensional representation of a three dimensional mapping. For the sake of brevity, the two dimensional representation of the three dimensional mapping will be referred to below as a “3d mapping”. Thus, the reference data may be three dimensionally modelled to provide the 3d mapping.

In another embodiment, the processor may be configured to produce a group map based on input data sourced from at least two individuals.

In a further embodiment, the processor may be configured to produce a community map based on input data sourced from a plurality of individuals, each of whom is a member of the community.

In still a further embodiment, the processor may be configured to generate a global map from the database, the processor further being configured to enable an individual to plan a course of action, and monitor progress as the individual takes action, on the global map.

The data analysis system may be configured to use social media networks for enabling the individual to access the global map. The processor may include web-enabled tools and analytics functionality to enable individuals to share information and access other web amenities such as wikis, on-line resources, etc.

The processor may be configured to enable an individual to customise the input data to the global map to generate a sub-population map containing special interest information, the individual being able to access the sub-population map to assess and track progress in relation to the special interest to which the special interest information relates.

In a fourth aspect, there is provided a data analysis system for analysing data relating to an individual, the system including

a physical computer based data generator for creating input data relating to an individual;

a physical computer processor responsive to the data generator, the processor being configured as a data analysis engine containing pattern recognition software and the processor being configured to manipulate and transform the input data to generate output data;

an output module configured as a part of the processor, the output module providing the output data to the individual in the form of a personal map, the map being the individual's personal map containing that individual's personal data relating to life experiences of the individual and the input data being manipulable by the individual to enable the individual to monitor change arising from one point on the map to another point on the map by inputting different input data into the processor; and

a storage module associated with the processor for storing the personal map of the individual.

### BRIEF DESCRIPTION OF DRAWINGS

An embodiment of the disclosure is now described by way of example with reference to the accompanying diagrammatic drawings in which:

FIG. 1 shows a schematic block diagram of an embodiment of a data analysis system for analysing data relating to an individual and illustrating the generation of an individual's map;

FIG. 2 shows a schematic block diagram illustrating the personalising of the individual's map by the individual;

FIG. 3 shows a schematic block diagram of the use of the system for generating a group map;

FIG. 4 shows a schematic block diagram of the use of the system for generating a community map;

FIG. 5 shows a schematic block diagram of the use of the system for generating a global map;

FIG. 6 shows a schematic block diagram of the use of the group map of FIG. 5 for generating a sub-population map; and

FIG. 7 shows a flow chart of an embodiment of a method of analysing data relating to an individual.

### DETAILED DESCRIPTION OF EXEMPLARY EMBODIMENT

In the drawings, reference numeral 10 generally designates an embodiment of a data analysis system. The data analysis system is intended for use by one or more individuals 12 in conducting self-assessment and assessment by others to assist the individual 12 to manage and deal with challenges the individual 12 may face in his or her life. It also enables the individual 12 to share his or her experiences with others and to benefit from the life experiences of others.

The data analysis system 10 is a computer implemented system making use of networking facilities such as the world wide web 14 for obtaining and sharing information.

The data analysis system 10 includes a main computer system or server 16 having a central processing unit, or processor, 18 configured as a data analysis engine, the purpose of which will be described in greater detail below. The server 16 includes a data generator which generates a web-based questionnaire 20 when requested by the individual 12, the questionnaire 20 being accessed on-line by the individual 12 via the individual's computer 22. Responses provided by the individual 12 to the questionnaire 20 are held in an individual web file by the server 16, the web file being accessible only by the individual 12. Any changes to the responses or new responses are uploaded and stored in the web file of the individual 12.

The processor 18 of the server 16 includes a processing module 24. As will be described in greater detail below, the processing module 24 of the processor 18 contains pattern recognition software which is configured to manipulate and transform input data, the input data being in the form of the responses to the questionnaire 20 provided by the individual 12. The system 10 further includes an output module 26 in communication with the processor 24 for providing output data, in the form of a map 28, to the individual 12. The map 28 is an individual's personal map containing that individual's personal data relating to the life journey, or life experiences, of the individual 12. For ease of description, the map 28 will be referred to below as a life map 28. The processing module 24 of the processor communicates with a storage module 25 for storing the life map 28.

The data analysis system 10 also includes a tools module 30 which, conveniently, is configured as a component of the processor 18 and which is accessible via the computer 22 of the individual 12 to enable the individual 12 to personalise his or her life map 28.

As will also be described in greater detail below, the system 10 is sufficiently versatile to enable the individual 12 to share to his or her experiences and to join with other individuals in forming group maps, community maps and, using a global map, to assess the life journey of the individual 12 and how changes can affect the life journey of the individual 12.

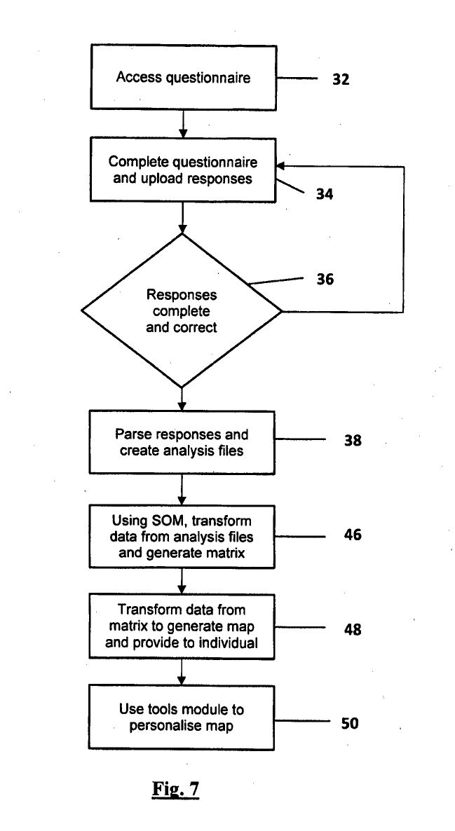

As shown at step 32 in FIG. 7 of the drawings, the individual 12 accesses the questionnaire on-line using his or her computer 22. The individual 12 completes the questionnaire 20. If this is the first time the individual 12 has accessed the system 10, and in order to enable the life map 28 to be generated, milestones in the individual's life are necessary and the individual can complete multiple questionnaires 20 representative of those milestones, the milestones representing key events, both past and present, in the life of the individual 12.

The individual 12 is able to use other responses in generating his or her own life map 28. To do so, the individual 12, using the processor 18, accesses a library of pre-completed or pre-generated questionnaires for other individuals, for example, heroes, sports stars, famous people, etc. (referred to in this paragraph as “subjects of interest”) to include in building the life map 28. Using such data sets to augment the individual's own completed questionnaire 20 when the individual 12 is building his or her life map 28 enables the individual 12 to place what could be his or her more limited life experiences in the context of a much wider set of life experiences of others of the individual's choosing. Data from the library can either be stored in a storage module (not shown) of the processor 18 or the processor 12 can access the library via the web 14.

When the individual 12 accesses the library, the data which the individual 12 obtains excludes responses as submitted by the subject of interest or any of the raw data associated with that subject of interest. The data set relating to the subject of interest are obtained by the processor 18 and used in the generation of the life map 28 of the individual 12. The individual 12 thus uses the responses of the subject of interest without seeing what the raw data relating to the subject of interest contain.

The individual 12 is also able to download or incorporate data from certain subsets of a global database 40 of the system 10 in the life map 28 to broaden the range of experiences for that individual 12. This is especially useful where the individual 12 may not have a great level of experience relating to a particular topic and/or it simplifies the task of completing the data required to generate the life map 28. Once again, any data from the global database are used by the data analysis engine without the individual 12 having sight of the contents of the raw data from the global database 40.

For example, the individual 12 is able to use information from the global database 40 relating to certain subsets of data relevant to the personal experience of the individual 12, for example, data relating to an ailment affecting the individual 12. The individual 12 is able to instruct the processor 18 to use the information associated with that data in the global database 40 in generating the life map 28, that subset of data augmenting the personal data of that individual 12.

The individual 12 completes the necessary number of questionnaires 20 and uploads the responses to the server 16 via the web 14 as shown at step 34, the responses forming part of a database 35 of individual responses. The responses of each individual are kept separate from one another in the database 35 and the responses of one individual are not used in generating the life map 28 of any other individual 12 nor are the responses of other individuals accessible by the individual 12. For example, some responses of individuals are shared in generating group or community maps, as will be described in greater detail below. However, the data required by the data analysis engine 18 to generate such group or community maps are obtained by the data analysis engine 18 from the database 35 directly without the members, or participants, of the group or the community having access to the data from the database 35. By having the responses separately stored in the database 35, the individual 12 is also able to alter or update his or her life map 28 at will and as often as desired.

On receipt of the responses to the questionnaire/s 20, the processor 18, operable as the data analysis engine, analyses the data to determine whether or not the questionnaires have been completed correctly and comprehensively as shown at step 36 in FIG. 7 of the drawings. If any questionnaire 20 is incomplete or incorrectly completed, this is communicated to the individual 12 who is afforded the opportunity to correct the necessary questionnaire/s 20. In addition, or instead, if the data are incomplete, the processor 24 of the data analysis engine 18 is configured to conduct mathematical imputing to complete missing data required to generate the life map 28 of the individual 12.

The applicant believes that at least thirty such questionnaires 20 will need to be completed by the individual 12 to enable a comprehensive life map 28 to be generated.

When operating as the data analysis engine, the processor 18 uses sophisticated pattern recognition techniques to analyse the responses uploaded to the server 16. To enable the responses from the individual 12 to be analysed, the responses to the questions are in the form of a graduated scale. For example, responses to a question may be in the form of a range between “worse now, same, better now”, “not at all, moderate, a high degree”, or the like.

The responses are parsed by the processor 18 as shown at step 38 in FIG. 7 of the drawings and the analysis files generated by the processor 18 are stored in the database 35 of individual responses and the global database 40. The global database 40 includes many thousands of responses from other individuals 12 but what is stored in the global database 40 are raw data extracted from the individuals' data but excluding personal identifiers or any other information from which an individual could be identified. Only the data associated with the individual 12 are used to generate the life map 28 of the individual, augmented, if necessary, with the additional data from subsets of the data from the global database, as described above. The individual 12 is also able to modify his or her life map 28 as often as desired.

The types of questions which are asked of the individual 12 in the questionnaire 20 are designed to measure individual perceptions of critical dimensions in the life of the individual, both now and in the past. As indicated, the questions are scored on a scale, typically from 1 to 7 and contain free-form text comments. The questions relate to the individual 12 insofar as they are applicable to the experiences, thoughts, feelings and perceptions, quality of relationships with important other persons in their lives and other significant figures in their life journey and the level of involvement and participation in the change that impacts on the life of the individual 12. In addition, questions relating to contextual factors relevant to the situation that the individual 12 is in, the type of life changing events taking place or having taken place and levels of turbulence are measured. Participation and involvement in groups and communities of which the individual is part are measured and the nature of the roles and responsibilities of the individual 12 are assessed. All the responses are also linked back to demographic variables such as age, gender, profession, interests, or the like.

The system 10 is able to be used by the individual 12 for assessing and managing external factors relating to that individual as well as internal self-management factors. External factors are applicable, for example, to relationships with others whereas internal, self-management factors are internally focussed and deal with issues such as personal feelings and experiences, awareness, mindfulness and consciousness. In general, the system 10 is applicable to enabling the individual to manage and assess factors included in the following, non-exhaustive list: feelings and experience, states of awareness, mindfulness and consciousness, quality of relationships, physical and psychological health, material wellbeing, effectiveness in achieving life goals, capacity for inner management, sensitivity, compassion, imagination, levels of cognitive complexity, changes taking place, career success, safety and security, participation in work and/or social groups, social and community activities; knowledge and capabilities, spiritual and cultural beliefs and values, and dimensions of self-identity and self-actualisation.

The processor 18, operating as the data analysis engine, conducts statistical analysis on the responses of the individual 12. The statistical analysis is, in particular, cluster analysis and, more particularly, non-linear, multivariate, dimension reduction. Other forms of cluster analysis which could possibly also be used include: learning vector quantization (LVQ), which is closely related to self-organising map algorithms described more fully below, k-means and robust k-means, forms of hierarchical clustering, partitioning around mediods (PAM), and expectation maximisation (EM).

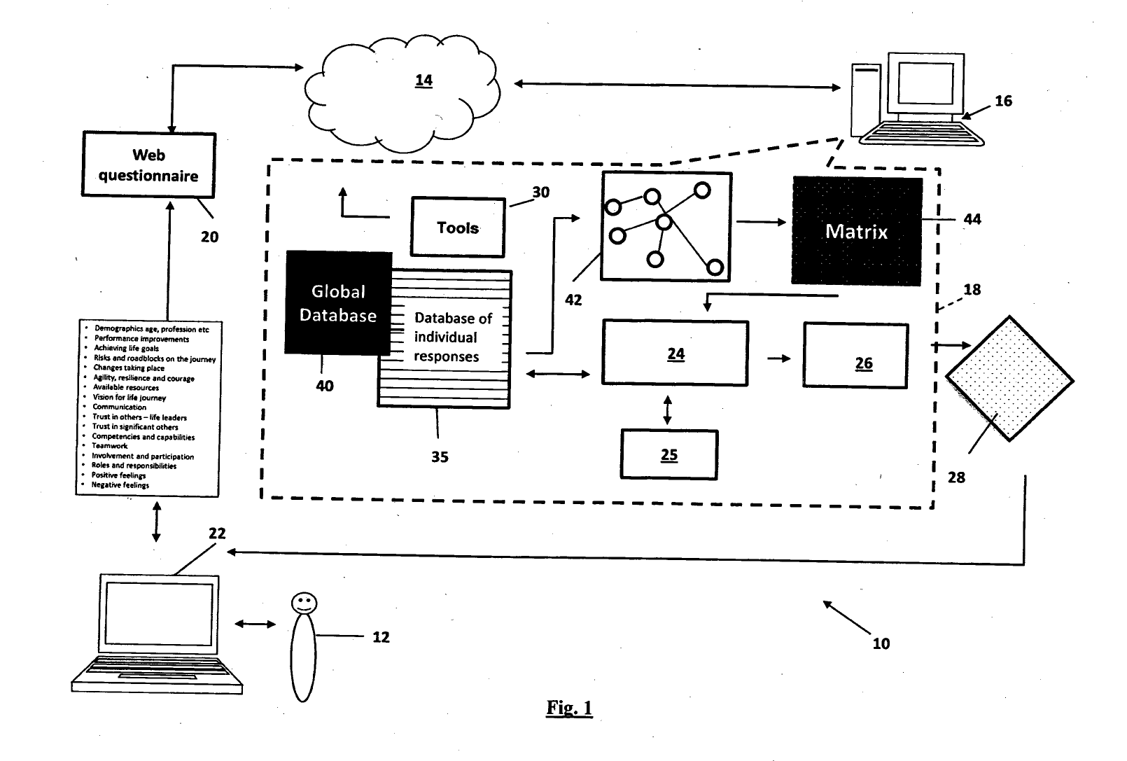

The processor 18 conducts the multivariate dimension reduction using a self-organising map algorithm (SOM) 42 (FIG. 1). The SOM 42 organises reference data produced by the processor 18 from the data contained in the responses of the individual 12 which are stored in the database 35 of individual responses. As an aside, it is to be noted that the system 10 also builds a global SOM using data from the global database 40 which is used to generate a global map as will be described in greater detail below. As previously indicated, any data for the global database 40 are stripped of data which could in any way identify any individual 12 before being stored in the global database 40 or used to build the global SOM.

In a SOM analysis, each sample is treated as a vector in an n-dimensional (n-D) data space defined by that sample's input variables. During an initial “training” phase of a SOM analysis, a set of seed vectors is distributed, typically randomly, within a data space. By means of an internal, iterative and largely unsupervised process, these seed vectors become trained (modified) to represent the character of the initial data set. Once the vectors have been modified they are known as code vectors (or “best matching units”).

An output of the SOM analysis is presented as a matrix 44. The size of the matrix 44 can vary, for example, a 5×5, a 12×10 or a 25×25 matrix 44. A number of preset sizes of matrices are stored in the tools module 30 and the individual 12 is able to select the desired size of the matrix 44. It is to be noted that the matrix 44 need not necessarily be a square matrix. The code vectors generated by the SOM analysis typically are displayed as a two-dimensional rectilinear arrangement of nodes in the form of a self-organising map. In other words, the matrix 44 is a self-organising map with each node of the map representing a code vector.

As indicated above, the applicant is of the view that at least 30 questionnaires, each containing multiple questions, typically about 40 questions, are required to enable a sufficiently comprehensive matrix 44 and resultant life map 28 to be generated. Those skilled in the art will appreciate that the analysis therefore results in a very large number of calculations to generate the matrix 44 and the map 28. As an example, for a reasonably simple life map 28 to be generated using 30 questionnaires, each containing 40 questions and to generate a 5×5 matrix 44, the number of calculations is 30×40×25=30,000 calculations. For a more complex individual life map 28 to be generated, up to 800 questionnaires may be required, each having 40 questions and a 25×25 matrix 44 being required. This requires 800×40×625=20,000,000 calculations to be effected by the processor 18.

To generate a complex group map, as described below, up to 50,000 questionnaires may be required, once again each with about 40 questions, and requiring a 25×25 matrix 44. This requires 50,000×40×625=1,250,000,000 calculations to be effected by the processor 18.

Hence, it will be readily appreciated that the software controlling the processor 18 is extremely complex and is essential to enable the matrix 44 and the life map 28 to be generated.

Thus, as shown at step 46 in FIG. 7 of the drawings, the processor 24, once the analysis has been carried out by the SOM 42, causes the matrix 44 to be generated. In turn, the life map 28 of the individual 12 is generated from the matrix 44 as shown at step 48 in FIG. 7 of the drawings.

Using functionality of the processor 18, the individual 12 can make choices about how the individual 12 wants to visualise his or her results on the life map 28. In this regard, it is common to display a map node in a colour that represents a particular attribute or parameter derived from the underlying code vector associated with that node. As the data input consists of mostly non-linear data, another useful technique is to create a 3d mapping, i.e. a 3-dimensional perspective of the life map 28, and to use the derived parameter or attribute of the particular node as the “elevation” on the life map 28. Also, because the SOM 42 is self-seeding and self-learning, each time the SOM 42 is run, a different life map 28 will be generated. Thus, the individual 12 is able to run and re-run the data through the SOM 42 as many times as desired in order to obtain the life map 28 that best suits the needs of that individual 12. Once finalised, the life map 28 of the individual 12 is stored in the storage module of the processor 18.

In addition, using the tools module 30 of the system 10, the individual 12 is able to personalise his or her life map 28 as shown at step 50 in FIG. 7 of the drawings.

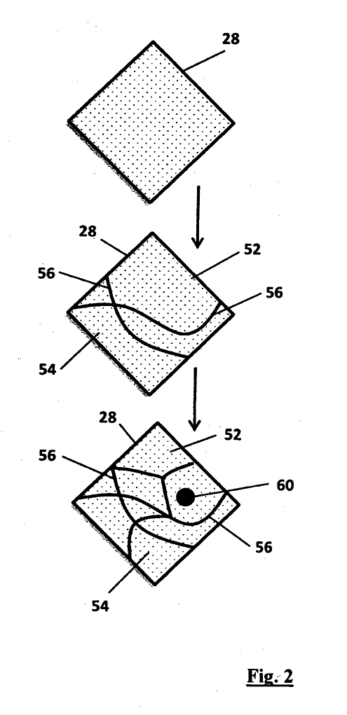

As shown more clearly in FIG. 2 of the drawings, personalising the map includes demarcating zones 52 and 54 on the life map 28. The zone 52 represents achieving one's life goals and the zone 54 represents not achieving one's life goals. The zone 52 for achieving one's life goals is shown at the top of the map 28 and the zone 54 for not achieving one's life goals is shown at the bottom of the map, the zones 52 and 54 being demarcated by lines 56.

The individual 12 can use other software tools from the tools module 30 to divide up the map into regions at 58 and to label and colour code those regions in accordance with different characteristics and features in his or her life journey. The individual 12 is also able to position himself or herself on the life map 28 as shown at 60 in FIG. 2 of the drawings. The individual 12 can further personalise the map 28 using video, audio, media, such as photos and images, and text which can be uploaded and included in the map 28. The map 28 thus constitutes the individual's personal “DNA” containing unique patterns in the life history and collective experiences of the life journey of the individual 12.

In addition, the map 28 can be uploaded by the individual 12 via the web 14, and, using social media networks, can be shared with other subscribers to those social media networks. Hence, a number of individuals 12 can share their life's journeys and experiences using the social media networks. In this way, individuals 12 are able to benefit from the experiences of others, can learn from others who have been in similar situations, can take steps to avoid mistakes made by others and learn from the successes of others.

When the individual 12 initially obtains the life map 28, the individual positions himself or herself on the map 28, as shown, for example, at 60 in FIG. 2 of the drawings. The location 60 represents the individual's particular place on the map 28 at that point in time in his or her life. In time, the individual 12 is able to complete further questionnaires and upload new responses into the processor 18 which illustrate how that individual has moved from the position 60 since the last provision of data. Point in time reports relating to the position 60 and any subsequent positions can be generated by the processor 18 and downloaded to the computer 22 of the individual 12. Multiple points can be made on an individual's life map 28 so that the individual 12 can check their progress across time. With point in time reporting, the individual 12 is able to see the driver profile of each cell (node) on the life map 28 by moving around each cell. The reporting in this fashion uses normalised data scores according to particular benchmarks that have been established through analysis of the global database 40, not raw input data scores. This enables the individual 12 to determine easily, based on graphical representations, how he or she can move from a point such as 60 on the map 28 to a different, better point, i.e. what actions the individual 12 needs to take to move to the latter point.

The processor 18 is sufficiently sophisticated so that the individual, via the web 14, can invite others to complete questionnaires 20, or to share their responses to their own questionnaires. This enables one individual to position himself or herself on the life map of another individual and to enable experiences to be shared. 360° type feedback tools enable feedback to be given from one individual to another and to enable one individual to receive feedback from another individual, for example, “what do you think of me?” and “what do I think of you?” Hence, colleagues, family members and/or friends can be invited “into” a life map 28 of an individual to participate as described. The individual 12 retains full control of his or her life map 28 and can remove anybody at any time. When any other individual “positions” on the life map 28 of the individual 12, this is effected by the SOM 42 and the individual 12 does not have sight of, or the ability to access, the raw data of the other individual. Reporting, once positioned in the cell of the map, is shared using normalised, benchmarked scores as described above.

When any new life map 28 is generated following uploading of new responses by the individual 12, features from the previous maps 28 are carried over and editing features enable the individual 12 to change those features and adjust them as required.

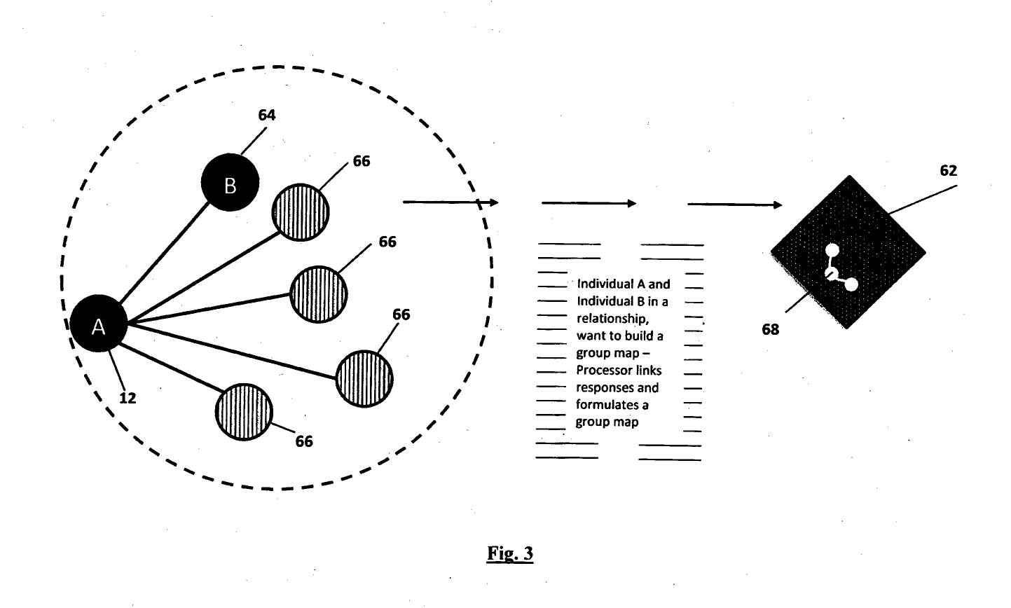

Referring to FIG. 3 of the drawings, an individual 12 can combine his or her own database of questionnaire responses with others to produce a group map 62. In this illustrated example, the individual 12, as shown by circle A in FIG. 3 of the drawings, wishes to share a group map 62 with another individual, for example, a spouse, B shown at 64 in FIG. 3 of the drawings. Also, as shown by the shaded circles 66, any number of additional individuals can be added to the group life map 62 as desired. In generating the group map 62, the processor 18 analyses data obtained from all participants in the group to create the group map 62 without any of the participants seeing, or having access to, the raw data of any of the other participants. The SOM 42 thus manipulates and transforms the data from the responses of all the participants of the group to generate the group map 62.

The individuals 12 and 64 can combine their results to gain insight into their combined life experiences and patterns of interaction. As another example, families are able to combine results to appreciate family dynamics better and the roles played by various members of the family. Instead, or in addition, groups of friends can combine either all or parts of their individual responses into friendship maps where they can track and monitor the quality of their relationships, the strength of the relationships they are forming and the patterns of social interactions. The group map 62, once formed, is able to personalised in the same way as the individual life map 28, as previously described. Also, as described above, 360°-type feedback applications are used with respect to the group map 62 to allow differences in perceptions of each other to be shared and insights to be gained. The functionality of the processor 18 includes value adding tools which enable relationship issues and difficulties to be understood and resolved. These tools enable participants in the group to be plotted on the map 62 spatially and the character, quality and strength of relationships between the participants to be assessed.

The tools module 30 also includes web enabled tools and analytics to enable the insights of the participants to be shared and for the individuals 12 to access web amenities such as wikis, dictionaries, other reference works, or the like. Instead of the tools module 30 containing these tools, the server 16 may access web enabled tools and analytics of third parties via the web 14. These wiki resources and web libraries enable the insights of the participants to be shared and gained and actions to be taken that lead to successful outcomes to be shared amongst the participants and, where applicable and as discussed below, across wider communities as well. For example, the individual 12 is able to interrogate the map 62 using these resources to ascertain what is required to improve his or her relationship with individual 64. The individual 12 can then take the recommended action and plot the progress on the group map 62.

As a further example, where the individuals 12 and 64 are members of a couple and they are in conflict, the individuals 12 and 64 could invite each other to participate and to take actions leading to resolution of the conflict. In an embodiment, the services of a skilled facilitator may be engaged by inviting that facilitator also to become a group participant and using other web-based resources. The skilled facilitator helps guide the conflict resolution process to achieve the best outcome. This is facilitated by the use of web-based technology and the sophisticated analytical capabilities afforded by the processor 18 which provides close to real time feedback. Thus, the data contained in the map 62 are able to be used to carry out predictive modelling and scenario planning, for example, “if you do X it will lead to outcome and position M (not shown) on the map 62 and if you do Y it will lead to outcome and position N (not shown) on the map 62”.

At any time during the currency of a group map 62, new individuals, for example, new family members such as children or new friends, can be plotted on the existing map or added into responses to formulate new or revised group maps. Conversely, responses can be deleted when individuals leave the group if required. Using the group map 62, journeys of the individuals, as shown at 68 can be plotted on the map 62 to determine if the life of each of the individuals is on track and what actions need to be taken.

Each individual 12, 64 is in control of the responses submitted in generating the group map 62 and whatever information the individual 12, 64 wishes to remain confidential can be excluded from the map 62. The individual 64 does not get access to the responses of the individual 12 and vice versa. All that the respondents see are the collective set of patterns generated in each cell or node on the map 62.

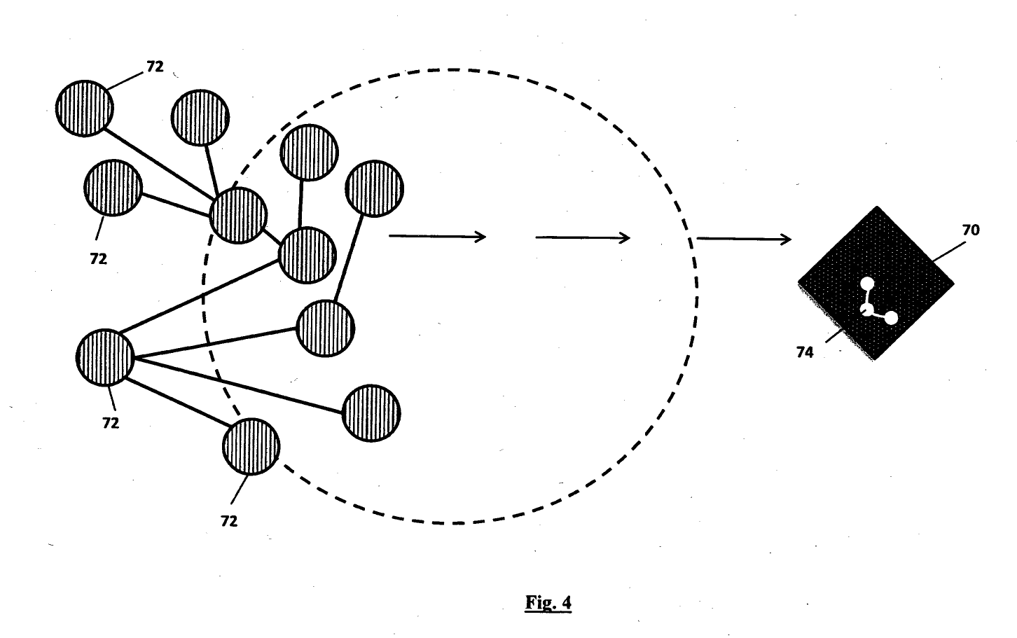

In another embodiment, a community map 70 is generated as shown in FIG. 4 of the drawings. The community map 70 relates to a community of individuals which have a collective history. For example, people having shared interests and common values can come together and form a community and generate the community map 70. As is the case with the group map, individuals 72, as shown by the shaded circles, all submit responses to the processor 18 individually. As with the case of the group map 62, the individual responses, and the raw data associated with the responses, are not made known to the other individuals of the community. Each individual 72 can tailor the responses which they submit so that data which they do not wish to have included are omitted from the responses.

The participants in the community locate themselves on the community map 70 and the information pertaining to each participant is only available to that participant. Once again, a dynamic aspect of the community map 70 is that, due to the speed of web resources, participants can share data relating to matters such as perceptions of one another, perceptions of the issues involved, or the like, and interact with one another effectively in real time. Each participant's position on the community map 70 moves as the perceptions change or resolution of issues occurs.

Individuals can be invited to participate in the community and their positions tracked as interactions between the participants occurs in a similar way to group therapy but on-line and interactive. Thus, as with the case of the group map 64, a skilled facilitator may be invited to participate.

Over time, the map 70 records the history and collective understanding, shared values and lessons learned in the community and members 72 of the community can track their journeys on the map as shown by the path 74 on the map 70.

It is to be noted that, in respect of both the group map 62 and the community map 70, the tools from the tools module 30, augmented if necessary by tools from the web 14, enable the group or the community to define and personalise their maps 62 or 70 as the case may be. New responses from members of the group or community are included in the maps 62 or 70. As individuals upgrade their responses or alter their responses, new individuals join or individuals leave the group or community the maps 62 or 70 are also updated. It is also to be noted that, in respect of both the group map 64 and the community map 70, patterns generated are provided in the form of the point of time reports that show only normalised data and not raw data responses.

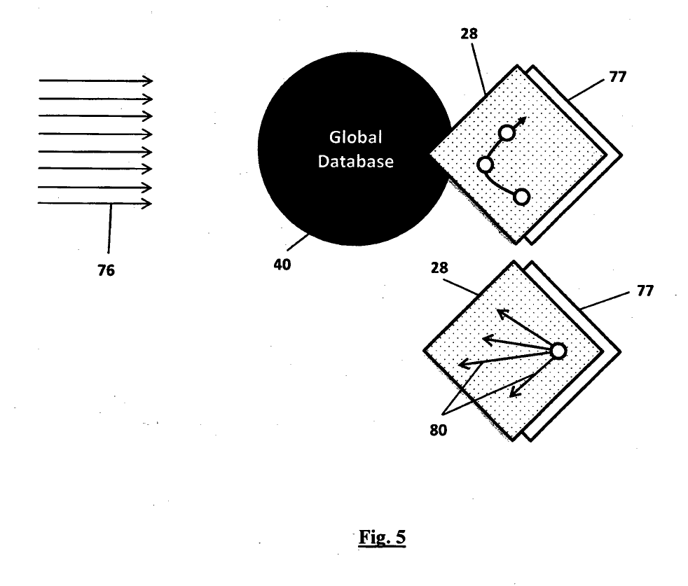

As described above, the system 10 relies on thousands of responses submitted by individuals 12 and which populate the global database 40, the responses being shown schematically in FIG. 5 of the drawings by arrows 76. The global map 77 is built as a master map using the SOM 42 and using the raw data of the individuals which are stored in the database 40. The global map 77 is periodically updated and is released to users of the system 10 as updated or new versions or releases. It will be appreciated that the generation of the global map 77 involves the processor 18 undertaking many millions, if not billions, of calculations. Each time the global map 77 is updated, those calculations need to be redone.

Using the processor 18, each individual 12 is able to compare his or her life journey with those of others and to gain insight into where that individual 12 is along his or her life journey and to learn from others who have been in similar situations to the individual 12. The individual 12 can discern the paths taken by others and decisions and actions that others in similar positions to that individual have taken that have led to success or failure. To effect this, the individual 12 accesses the global database 40 and overlays his or her responses as displayed on his or her life map 28 relative to an underlying global map 77 to track the individual's path as shown at 78 on the life map 28.

The path 78 enables the individual 12 also to locate himself or herself on any group map 62 or community map 70. In doing so, the individual can assess where they are in comparison to other people in similar life situations to that individual at that point in time. The individual can, as described above, indicate what steps the individual needs to take which can lead to success in a particular situation and how the individual can learn from the mistakes and failures of others who have been in similar situations so as, if possible, not to repeat the mistakes of others.

The functionality associated with the processor 18 has predictive capabilities. Thus, when an individual has completed two or more questionnaires, different points on the life map 28 can be generated using sophisticated pattern recognition as provided by the SOM 42 which enables movement on the life map 28 to be tracked, as shown by arrows 80. These arrows 80 represent the main paths which many hundreds or thousands of people have taken in following different courses of action so that the individual 12 is able to predict what outcome will arise be by following a particular course of action. Thus, the individual 12 is able to use this information to plan a course of action and to monitor progress as the individual 12 takes the relevant course of action. It will be appreciated that only the main paths 80 are shown since, in practice, there are a very large number of possible paths taken by the population but not all can be sensibly displayed.

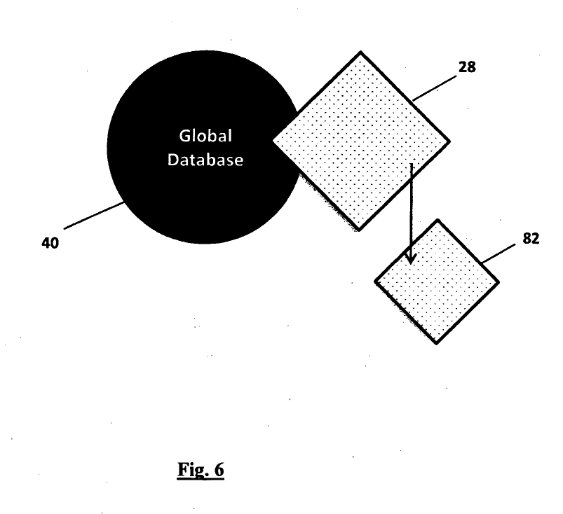

Referring now to FIG. 6 of the drawings, a sub-population map 82 is shown. The sub-population map 82 relates to special interest groups of which the individual 12 may be a member. As an example, the map 82 can be built for specific sub-populations using data from the global database 40. This enables particular areas of interest or study to be carried out and individuals within those sub-populations to use the map 82 to assess and track their progress. Such sub-population maps 82 are, generally, owned by leaders of the sub-population, for example, academic or professional bodies, and such maps 82 facilitate research in those areas. As is the case with other maps, the data used in generating the sub-population map 82 are built using raw data that has been stripped of any data which could be used to identify the participants. The participants do not get to see the data of others, the data only being used by the SOM 42 to generate the sub-population map 82.

As an example, if an individual 12 suffers from a particular illness or disability, the individual 12 can be subscribed as a member of a sub-population containing other members with similar ailments and, in so doing; the individual 12 can assess his or her progress in relation to those other members of the sub-population. It is also beneficial for the individual 12 to be able to share experiences 12 with other members of the sub-population, to get support from those members and to provide support to other members. The processor 18 is configured to use benchmarks relating to the sub-population to normalise the data of the individual 12 as it applies to the sub-population, for example, “how do I compare with . . . ?”

It is therefore an advantage of the disclosure that a data analysis system 10 and method are disclosed which enables an individual to share his or her life journeys and to take steps to manage and improve on that life journey and enjoyment of life. In addition, by using social media networks, individuals are able to gain deeper insight and understanding into the nature of their relationships, identify critical issues and help/guide people into what they can do about issues in their lives, in particular, what leads to success in life based on the experience of others.

Further, the data generated and displayed in the various maps are able to be used by researchers and academics for educational purposes. For example, using a metric of “stopping smoking”, it is possible to determine methods of doing so, to plot the benefits of doing so and, conversely, the consequences of not doing so, modelling the impact of heart attacks on a particular segment of the population, e.g. males over a certain age of a region, etc.

In populating the global database 40 and in generating all multi-participant maps, such as the group map 64, the community map 70, the global map 77 or the sub-population map 82, only desensitised data with limited demographics are used. No individual's names nor any other data which would enable an individual to be identified are used. The multi-participant maps all use point in time recording techniques with only normalised data being shown.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A method of analysing data relating to an individual, the method including
providing input data relating to an individual to a physical computer processor configured as a data analysis engine containing pattern recognition software;
using the processor to manipulate and transform the input data to provide output data;
using the processor to transform the output data into the form of a personal map and storing the map, the map being the individual's personal map containing that individual's personal data relating to life experiences of the individual; and
providing tools to enable each individual to personalise his or her personal map.

2. The method of claim 1 which includes periodically updating the map by plotting new responses on the map and using the processor to update the map.

3. The method of claim 2 which includes, when updating the map, retaining personalisation of the map previously added by the individual.

4. The method of claim 1 which includes using a web-based selection of tools to personalise the map.

5. The method of claim 1 in which the map is an individual map and in which the method includes combining the individual maps of a number of individuals to generate a group map.

6. The method of claim 5 which includes generating the group map by combining input data from members of the group who wish to combine their individual maps to form the group map, the processor linking and combining the input data to output the group map.

7. The method of claim 6 which includes adding members to, or removing members from, the group as desired by combining or deleting the input data of the members as required.

8. The method claim 5 which includes generating a community map from the input data of a plurality of individuals, each of whom is a member of the community.

9. The method of claim 1 which includes generating a global map from the input data of many individuals.

10. The method of claim 9 which includes enabling the individual to access the global map to compare the situation of that individual with other individuals whose input data has contributed to the global map.

11. The method of claim 9 which includes enabling an individual to plan a course of action on the global map.

12. The method of claim 9 which includes using social media networks for accessing the global map.

13. The method of claim 12 which includes, using web-enabled tools and analytics functionality of the processor, enabling individuals to share information and access other web amenities.

14. The method of claim 9 which includes, by customising the input data to the global map, generating a sub-population map containing special interest information.

15. The method of claim 14 which includes enabling the individual to access the sub-population map to assess and track progress in relation to the special interest to which the special interest information relates.

16. A method of analysing data relating to an individual, the method including
providing input data relating to an individual to a physical computer processor configured as a data analysis engine containing pattern recognition software;
using processor to manipulate and transform the input data to provide output data;
using the processor to transform the output data into the form of a personal map and storing the map, the map being the individual's personal map containing that individual's personal data relating to life experiences of the individual; and
using the processor to monitor change arising from one point on the map to another point on the map by the individual inputting different input data into the processor.

17. A data analysis system for analysing data relating to an individual, the system including
a physical computer based data generator for creating input data relating to an individual;
a physical computer processor responsive to the data generator, the processor being configured as a data analysis engine containing pattern recognition software and the processor being configured to manipulate and transform the input data to generate output data;
an output module configured as a part of the processor, the output module providing the output data to the individual in the form of a personal map, the map being the individual's personal map containing that individual's personal data relating to life experiences of the individual;
a storage module associated with the processor for storing the personal map; and
a tools module in communication with the processor and accessible by the individual for enabling the individual to personalise his or her personal map.

18. The system of claim 17 in which the input data, when received, forms part of source data for future use, the system including a database containing the source data.

19. The data analysis system of claim 17 in which the processor is configured to perform cluster analysis at least on the input data to produce reference data.

20. The data analysis system of claim 19 in which the form of cluster analysis is non-linear, multivariate, dimension reduction.

21. The data analysis system of claim 20 in which the non-linear, multivariate, dimension reduction uses a self organising map algorithm (SOM) for organising the reference data into a matrix from which the personal map of the individual is generated.

22. The data analysis system of claim 17 in which the data analysis engine functionality of the processor is configured to transform the input data into an analysis file to be processed by the processor.

23. The data analysis system of claim 22 in which the analysis file includes input variables which are processed by the processor to generate the output data.

24. The data analysis system of claim 17 which includes presenting the map as a two dimensional representation of a three dimensional mapping.

25. The data analysis system of claim 17 in which the processor is configured to produce a group map based on input data sourced from at least two individuals.

26. The data analysis system of claim 17 in which the processor is configured to produce a community map based on input data sourced from a plurality of individuals, each of whom is a member of the community.

27. The data analysis system of claim 17 in which the processor is configured to generate a global map from the database, the processor further being configured to enable an individual to plan a course of action on the global map.

28. The data analysis system of claim 27 which is configured to use social media networks for enabling the individual to access the global map.

29. The data analysis system of claim 28 in which the processor includes web-enabled tools and analytics functionality to enable individuals to share information and access other web amenities.

30. The data analysis system of claim 27 in which the processor is configured to enable an individual to customise the input data to the global map to generate a sub-population map containing special interest information, the individual being able to access the sub-population map to assess and track progress in relation to the special interest to which the special interest information relates.

31. A data analysis system for analysing data relating to an individual, the system including
a physical computer based data generator for creating input data relating to an individual;
a physical computer processor responsive to the data generator, the processor being configured as a data analysis engine containing pattern recognition software and the processor being configured to manipulate and transform the input data to generate output data;
an output module configured as a part of the processor, the output module providing the output data to the individual in the form of a personal map, the map being the individual's personal map containing that individual's personal data relating to life experiences of the individual and the input data being manipulable by the individual to enable the individual to monitor change arising from one point on the map to another point on the map by inputting different input data into the processor; and
a storage module associated with the processor for storing the personal map of the individual.
